(19) United States
(12) Patent Application Publication
(10) Pub. No.: US 2014/0317240 A1
(43) Pub. Date: Oct. 23, 2014

(54) SYSTEMS AND METHODS FOR STREAMING VIDEO PROGRAMS WHILE INTEGRATING ACCOUNTABILITY AND COMMUNICATION

(71) Applicant: Xstreaming Fitness L.L.C., West Des Moines, IA (US)

(72) Inventors: David H. Handsaker, Winterset, IA (US); Michael G. Andersen, Clive, IA (US)

(73) Assignee: Xstreaming Fitness L.L.C., West Des Moines, IA (US)

(21) Appl. No.: 14/206,544

(22) Filed: Mar. 12, 2014

Related U.S. Application Data
(60) Provisional application No. 61/777,560, filed on Mar. 12, 2013.

(51) Int. Cl. H04L 29/06

(52) U.S. Cl. CPC H04L 65/602
USPC 709/219

(57) ABSTRACT

Systems and methods for streaming video programs while integrating accountability and communication are provided. The system may include first and second recording devices, which record first and second feeds of a target. The system may include a first computing device to stitch the first and second feeds into an integrated feed. A trigger may be activated by the target to transition between the first and second feed to create the integrated feed. A second computing device may display at least one of the feeds. Other systems of the present invention may include first and second computing devices, which may provide a communication platform between users. In addition, at least one of the users may be enabled to provide accountability information to the system, thereby enhancing communication between the users. Methods of employing a system of the present invention are also provided.

### FIELD OF THE INVENTION

The present invention generally relates to software systems and methods. More specifically, the present invention relates to systems and methods for streaming programs while integrating accountability and social networking.

### BACKGROUND

About 20% of the population in the United States belongs to a fitness club. Many fitness clubs direct their attention to attracting new membership, while spending little energy on retaining current membership. Accordingly fitness clubs lose 10.7 million members annually, with an annual chum rate of 24%. The top reasons members leave a fitness club are scheduling inconvenience, lack of variety, location inconvenience and expense. Some fitness clubs are able to address some of these concerns but not all. For example, many 24 hour fitness clubs remedy scheduling inconvenience and expense and traditional big box clubs remedy concerns about variety by providing a wide variety of classes and equipment. Also popular are extreme body shaping boot camps; however, many gyms are unable to offer enough classes during popular class times. Moreover, many members must travel long distances to reach an extreme body shaping boot camp facility.

Some people choose to work out at home as opposed to at a fitness club. This is helpful in remedying scheduling and location inconveniences, and in some cases the expense of joining a fitness club. However, there are also drawbacks to this strategy. Oftentimes, individuals who work out at home are limited to a few videos or pieces of equipment. Accordingly, there is a lack of variety in at-home fitness routines, which leads to boredom and does not provide optimum physical results.

Accordingly, there exists a need in the art for systems and methods to address the concerns of scheduling inconvenience, lack of variety, location inconvenience, and the expense of current fitness options. Therefore, systems and methods are provided that address the aforementioned concerns by streaming and/or recording fitness sessions for delivery to users.

### SUMMARY

The present invention provides systems and methods for streaming video, accountability, and communication. In one embodiment, a system of the present invention may include a first recording device to record a first feed of a target, which may be an instructor, a second recording device to record a second feed of the target, a trigger, and a first computing device. The first computing device may include a first processor and a first machine readable medium. The first machine readable medium may store a first set of instructions that, when executed by the first processor, cause the first processor to execute a first set of operations. The first set of operations may include receiving at least one signal from the trigger, stitching the first feed and second feed into an integrated feed, and transmitting at least one of the first, second, and integrated feeds. In addition, the trigger may be activated to transition the integrated feed between the first feed and the second feed. Moreover, the target may activate the trigger to transition between the first and second feeds to create the integrated feed. The trigger may be global positioning system enabled. The first, second, and integrated feeds may be selected from the group consisting of a fitness class, speech, security camera feed, performance, and a meeting, conference, seminar or workshop.

In some embodiments, the system may further include a second computing device having a second processor and a second machine-readable medium. The second machine-readable medium may store a second set of instructions that, when executed by the second processor, cause the second processor to execute a second set of operations including displaying at least one of the first, second, and integrated feeds. In addition, at least one of the first and second sets of operations may further include providing at least one of a communication outlet and a social media outlet. The first set of instructions may further include providing a communication platform for a user of the first computing device to communicate with a user of the second computing device. The second set of instructions may also include providing a platform for a user to enter accountability information. The accountability information may be a goal, progress towards a goal, and combinations thereof. In addition, the accountability information may be linked to at least one social media platform. The first and second computing devices may be selected from the group consisting of a desktop computer, laptop computer, tablet computer, gaming console, mobile phone, server, and television.

In another embodiment, the system may include a first computing device and a second computing device. The second computing device may include a second processor and a second machine readable medium. The second machine readable medium may store a set of instructions that, when executed by the second processor, cause the second processor to execute operations including providing a platform for a user to enter accountability information. The first computing device may include a first processor and a first machine readable medium. The first machine readable medium may store a set of instructions that, when executed by the first processor, cause the first processor to execute operations including displaying the second user's accountability information and providing a platform for a user of the first computing device to communicate with the user of the second computing device.

In some embodiments of the above-described system, the first user may be an instructor and the second user may be a student. The accountability information, which may be shared on social media, may be selected from the group consisting of a goal, progress toward a goal, class attendance, class progress, and combinations thereof. In addition, the first set of instructions may further include providing the first user with at least one personalized message to send to the second user. The communication from the first user to the second user may be via text message, short message services, email, social media, or combinations thereof. The first and second computing devices may be selected from the group consisting of a desktop computer, laptop computer, tablet computer, gaming console, mobile phone, server, and television. Furthermore, at least one of the first and second computing devices may receive information from a tracking device. In addition, the system may provide at least one of an audio or video bridge between the first and second computing devices.

Also provided is a computer-implemented method. The method may include recording a first and second feeds of a target and creating an integrated feed by switching between the first and second feeds. The switching may be actuated by a trigger which is activated by the target. A first computing device may transmit the integrated feed to a second computing device, which displays the integrated feed. The second computing device may also receive and store accountability information, which it may also communicate to the first computing device. The first computing device may display the accountability information and provide a platform for a user of the first computing device to communicate with a user of the second computing device. In some embodiments, the method may also include the first computing device sending at least one message to a user of the second computing device based on the accountability information. The accountability information may be a goal, progress toward a goal, class attendance, or combinations thereof.

### BRIEF DESCRIPTION OF THE DRAWINGS

FIG. 1 is a schematic diagram of a system of the present invention including first and second recording devices; a trigger; a tracking device; first, second, and third computing devices each including a processor and machine-readable medium; and a network in accordance with one or more examples of a system of the present invention.

FIG. 2 is a flow chart according to a method implementing a streaming video, accountability, and communication system in accordance with one or more examples of a system of the present invention.

FIGS. 3-15 are sample user interfaces of a system of the present invention.

FIG. 16 is a schematic diagram of a system of the present invention integrating multiple recording devices into a single feed based on trigger data in accordance with one or more examples of a system of the present invention.

FIG. 17 is a schematic diagram of a recording space according to a system of the present invention in accordance with one or more examples of a system of the present invention.

FIG. 18 is a flow chart of exemplary recording logic of a system of the present invention in accordance with one or more examples of a system of the present invention.

FIG. 19 is a flow chart of exemplary logic of a system of the present invention to provide users with the ability to input, store, and track accountability data in accordance with one or more examples of a system of the present invention.

FIG. 20 is a flow chart of exemplary logic of a system of the present invention to provide users with a pre-populated messaging platform in accordance with one or more examples of a system of the present invention.

FIG. 21 is a flow chart of exemplary logic of a system of the present invention to provide users with a communications platform to interact with other users of the system in accordance with one or more examples of a system of the present invention.

FIG. 22 is a flow chart of an exemplary user interface map for a general user of a system of the present invention in accordance with one or more examples of a system of the present invention.

FIG. 23 is a flow chart of an exemplary user interface map for an instructor and/or administrator of a system of the present invention in accordance with one or more examples of a system of the present invention.

### DETAILED DESCRIPTION

The following is a detailed description of an embodiment of a system for streaming video, accountability, and communication (sometimes “system”), as well as an embodiment of a method for streaming video, accountability, and communication (sometimes “method”). One particular use of such a system and method is for streaming a fitness class offered at a location remote from a viewer, also referred to as a second user, user of a second computing device, participant, and student. For ease of discussion and understanding, the following detailed description will refer to the aforementioned fitness class embodiment of the present invention. However, it will be appreciated by one skilled in the art that a system and method of the present invention may be used in a number of circumstances, including, but not limited to, all types of classes and education, to transmit and view speeches, security camera feeds, performances, church events and sermons, and at meetings, conferences, seminars and workshops. Accordingly, systems and methods of the present invention may (1) enhance an experience for an on-site participant, and (2) virtualize the experience and opportunity for a remote participant.

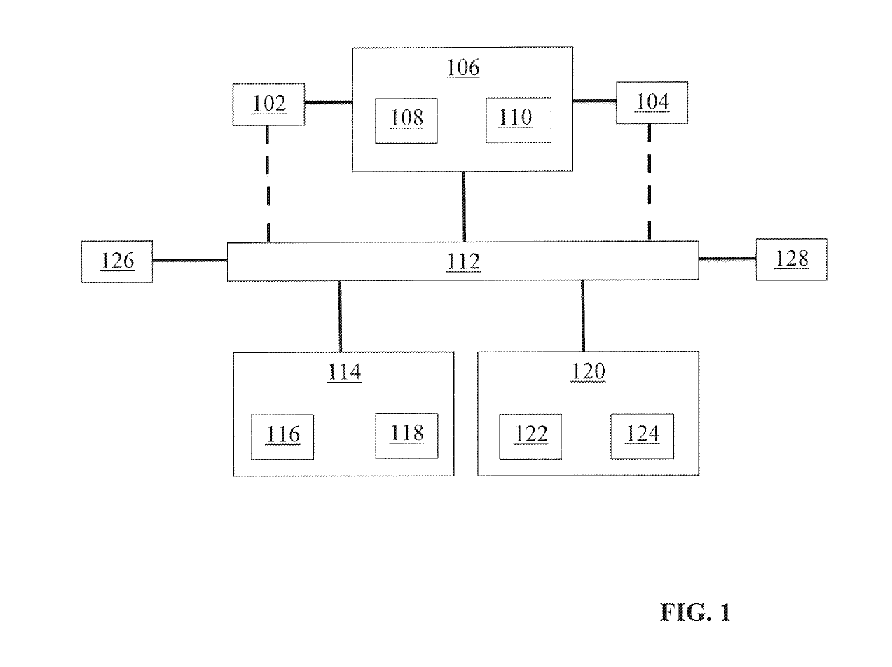

Referring to FIG. 1, a schematic of an embodiment of a system of the present invention is shown. The system includes a first recording device 102 and a second recording device 104. The first recording device 102 records a first feed of a target, and the second recording device 104 records a second feed of the target. It is anticipated that the target will not be stationary, such as a person moving about a room. Accordingly, the first and second feeds are generally of the same event, but different views of same. For example, in a fitness class, the first recording device 102 may be focused on the instructor's usual location, such as in the front, center of the room. The second recording device 104 may be focused on the remainder of the classroom, such as where students are generally located. In this way, the combination of the two recording devices 102, 104 may record the instructor at his or her usual location and also if the instructor moves to assist an in-person student. Also included is a trigger 126. As will be discussed in further detail below, the trigger 126 may be activated to switch between the first feed and second feed to create an integrated feed.

Also included in the present invention is a first computing device 106. The first computing device 106 includes a first processor 108 and a first machine-readable medium 110. The first machine-readable medium 110 may store a first set of instructions that, when executed by the first processor 108 cause the first processor 108 to execute functions including receiving at least one signal from the trigger 126, stitching the first and second feeds into the integrated feed, and transmitting at least one of the first, second, and integrated feeds. The first set of instructions may provide for further operations, which will be discussed in further detail below. As discussed above, the trigger 126 may be activated to transition the integrated feed between the first and second feeds. Furthermore, the target may activate the trigger 126 to transition between the first and second feeds to create the integrated feed. In one embodiment, the trigger 126 may be a small fob or other device that may be carried by the target and manually activated. In other embodiments, the trigger 126 may provide automatic switching of the feeds, such as via a global positioning system (GPS) enabled device, a radio frequency identification enabled device (RFID), a face-tracking device, local triangulation sensors, or any other type of device allowing the target to activate the trigger 126 to switch between the first and second feeds. Accordingly, as an instructor moves from his or her usual location at the front of the classroom to students at different locations in the classroom, the first computing device 106 stitches the first and second feed as appropriate to create an integrated feed for a remote viewer. Furthermore, systems and methods of the present invention do not require a director to switch feeds or direct content. This may be advantageous in small group settings where employing a director is cost prohibitive.

In one or more embodiments, the first computing device 106 may be a general purpose computer or a data processor selectively activated or reconfigured by a stored computer program or a separately constructed computing platform for carrying out the features and operations disclosed herein. Furthermore, the first computing device 106 may be a tablet computer, server, mobile device, or any other type of computing device known now or in the future. The first 102 and second 104 recording devices may be directly connected to the first computing device 106, as shown by the solid lines in FIG. 1. Alternatively, the first 102 and second 104 recording devices and first computing device 106 may be connected to a network 112 and communicate indirectly through the network 112, as shown by the broken lines in FIG. 1. The first computing device 106 may further provide a user interface for an instructor to track attendance, both in-person and online. view accountability information, and make comments to students, which will be discussed in further detail below. The instructor may also view at least one of the first, second, integrated, or other feeds, and in some embodiments may be alerted as to the non-integrated feed that is being stitched into the integrated teed.

Systems of the present invention may also include a second computing device 114. The second computing device 114 may include a second processor 116 and a second machine-readable medium 118. The second machine-readable medium 118 may store a set of instructions that, when executed by the second processor 116. cause the second processor 116 to execute operations including displaying at least one of the first second, and integrated feeds. The second set of instructions may also provide further operations, which will be discussed in further detail below. Accordingly, a user of the second computing device 114 may view the integrated feed via the second computing device 114.

The second computing device may be a mobile phone, tablet computer, laptop computer, desktop computer, gaming console, television, or any other device capable of displaying at least one of the first, second, and integrated feeds, known now or in the future. In some embodiments the display will be directly on the second computing device 114 itself, such as with a mobile phone, tablet computer, laptop computer, or some televisions. In other embodiments, the second computing device 114 will send a signal to another device to display the streaming video and other display features, such as a desktop computer sending the signal to a monitor or a gaming console sending the signal to a television. It is also anticipated that a user may choose from the first, second, integrated feed and/or other feeds for viewing. In some embodiments, a user may have a limited period of time within which to view a class. In such an embodiment, a user may be allowed a brief preview, such as two to three minutes, to determine if he wishes to view the class. Moreover, the second computing device 114 may further display advertising messages. In some embodiments, it is anticipated that the second computing device may be a kiosk. Such a kiosk may be provided by employers to employees, hotels to guests, other fitness clubs, a doctor's or other health professional's office, or any location that may benefit from providing individuals with the opportunity to stream and/or remotely participate in an activity, including but not limited to a fitness class. Such a kiosk may include means for display, sound, and control of the content.

At least one of the first computing device 106 and second computing device 114 may further provide at least one of a communication outlet and a social media outlet. Accordingly, the users of the first computing device 106 and second computing device 114 may communicate with each other. In some embodiments, a student may communicate with the instructor of the fitness class. The communication may take place by any means known in the art now or in the future. Examples include, but are not limited to, video conference, audio conference, text message, short message service (SMS), blast messaging, and internet chat. In addition, the social media outlet may display a user's friends in the class or program. A user may view friends who are also online, at least a portion of friends' accountability data, and provide a communication outlet for a user and his or her friends. For example, a user and friend(s) may stream a class simultaneously and talk while doing so. However, a user may also mute friends who are online at the same time. The social media outlet may also include third party social media outlets, such as Facebook and Twitter. As will be discussed in further detail below, users may choose to share messages and accomplishments from the system through third party social media outlets.

The second computing device 114 may be further programmed to provide a platform for the user to enter accountability information or data. Accountability information may include, but is not limited to, goals, progress towards goals, completion or missing of classes, nutritional tracking, outside workout and fitness factors, and games/contests. Moreover, the second computing device 114 may make at least a portion of the user's accountability information visible on at least one social media outlet. The user's accountability information may also be synchronized between the first and second computing devices 106, 114 thus allowing the first computing device 106 to store said accountability information in a database. The accountability aspect of the invention may further provide means for an instructor to comment on a viewer's progress, such as providing encouragement or instruction through the use of a thin client connected to the first computing device 106, which will be discussed in further detail below. It is anticipated that in some embodiments, after a user views a class, the second computing device 114 will prompt the user to enter accountability information and/or provide messages regarding the user's upcoming schedule.

The system may further include at least one tracking device 128. The tracking device 128 integrated into the system may allow for automatic triggering between the first and second recording devices 102, 104. For example, the tracking device 128 may be associated with the target and include GPS or RFID capability to automatically track the location of the target to determine which feed to include in the integrated feed at a particular time. In other embodiments, the tracking device 128 may be associated with a student or other non-target user of the system 100. For example, it is anticipated that a user worn feedback device and/or external body tracking device may be integrated into the system to provide automatic feedback during a user's session and provide real-time feedback of user's progress to instructors. Such a user-worn feedback device and/or external body tracking device may also be capable of inputting user accountability information automatically into the system 100. For example. Fitbit or Xbox Kinect brand devices may be used. In addition, other tracking devices such as a wireless scale for recording weight or a heart rate monitor may be employed. As one of skill in the art will appreciate, any type of tracking device may be added to the system matrix without departing from the scope of the present invention.

A second embodiment of the system of the present invention may include the first computing device 106 and the second computing device 114. The second computing device 114 may include the second processor 116 and second machine-readable medium 118. The second machine-readable medium may include a second set of instructions that, when executed by the second processor 116 cause the second processor to execute operations including providing a platform for a user, such as the second user who may be a student, to enter accountability information. Moreover, the first computing device 106 may include the first processor 108 and first machine-readable medium 110. The first machine-readable medium 110 may store a first set of instructions that, when executed by the first processor 108 cause the first processor 108 to execute operations including displaying the second user's accountability information and providing a platform for a user, such as the first user or instructor, to communicate with the second user.

The accountability information may include, but is not limited to a goal, progress towards a goal, class attendance, class progress, and combinations thereof. For example, a user may set a goal related to weight loss, body fat percentage, classes attended per week, nutrition, smoking cessation, or other desirable habits. Furthermore, it is anticipated that one of the first or second computing devices 106, 114 may prompt a user to provide accountability information. For example, when a user signs into an account with the system 100, at least one of the first or second computing devices 106, 114 may ask questions including, but not limited to, the user's current weight, whether the user attended class that day, whether the user streamed class at home that day, what the user ate, etc. In addition, it is anticipated that a component of the system 100, such as the first computing device 106, may send messages, such as SMS, text, social media, or email messages, to a user soliciting accountability information. The information provided by the user may automatically be stored by the system, such as in the first computing device 106. Accordingly, all students of a fitness class running from 6 a.m. to 7 am. each weekday may receive a text message shortly after 7 a.m. asking if the user went to class. The user's response may be automatically saved by the system 100, such as by the first computing device 106, for display to the user, as well as other users including the instructor.

As discussed above, the first computing device 106 may provide a platform for a user of same to communicate with a user of the second computing device 114. Specifically, it is anticipated that the first computing device 106 will provide information including all students, clients, etc. to the instructor or other service-provider, which will also include accountability information. Accordingly, the instructor or other service-provider may provide messages including personalized or semi-personalized comments and encouragement to the student or other client. For example, a fitness instructor may send messages such as “Great job attending class all week”. “Sony we missed you Monday and Wednesday. I hope we see you on Thursday”, or “Congratulations on dropping your first five pounds”. In some embodiments, the system may prompt the instructor to send the described messages or with information described below regarding previous messages. The messages may be by SMS, text, email, social media, or any other type of communication known now or in the future. In addition, the first computing device 106 may store and provide to the instructor all previous messages sent to a specific participant. Therefore, the instructor may vary the messages that are sent so that the participant feels a greater connection with the instructor and may not realize that the instructor is aided by the system in creating and sending messages to the participant. Similarly, the frequency of the messages may be stored for like reasons. Completely automated messages may also be used, but it is anticipated that some degree of instructor freedom will be advantageous.

Accordingly, the present invention may provide a computer-implemented method of communication. The method may include providing at least a first computing device, storing accountability information in a database which is entered by at least one of a user and a tracking device, and displaying the accountability information and providing a communication platform for electronic communication between at least two users. As will be understood by one of skill in the art, the method may be carried out by a number of systems and computing devices, which may be connected via a network, as required by a particular application. For example, a single computing device or server may be employed, two computing devices may be employed, three computing devices may be employed, or other configurations as appropriate.

Although it is anticipated that in many embodiments, the user of the first computing device will be a fitness instructor, a number of other users may benefit from a system of the present invention. For example, physical therapists, physicians and other health professionals, nutritionists and dieticians, teachers, college professors, and others may benefit. Students, clients, or other customers may enter goals related to any of the above for viewing by the first computing device 106 user. Furthermore, the first and second computing devices 106, 114 may each be any device capable of performing the described functions, including, but not limited to a general purpose computer, such as a desktop or laptop computer, tablet computer, gaming console, mobile phone, server, and/or a television.

Furthermore, the user of the second computing device 114 may interact with users of other computing devices. In some embodiments. a system of the present invention may further include a third computing device 120. The third computing device 120 may include a third processor 122 and a third machine-readable medium 124. The third machine-readable medium may store a third set of instructions that, when executed by the third processor 122. cause the third processor 122 to execute operations including displaying at least one of the first, second, and integrated feeds and providing at least one of a communication outlet and a social media outlet. Furthermore, the user of the second computing device 114 and the third computing device 120 may communicate via communication channels provided by the second 114 and third 120 computing devices, such as an audio bridge or video bridge. The two users may communicate by any means known in the art, now or in the future, such as those enabled by a computer including, but not limited to video conference, audio conference, internet chat, and social media communications.

Moreover, the third set of instructions may further include providing a platform to enter accountability information. In addition, both the second and third sets of instructions may further be programmed to display at least a portion of the other user's (or users') accountability data. In this way, if a user of the second computing device 114 enters accountability information, a user of the third computing device 120 may view at least a portion of the user's accountability information. It is anticipated that a user's preferences for sharing of accountability information may be programmed as the user desires. However, alternative embodiments, such as automatic or default sharing of accountability information are anticipated. Moreover, the sharing of accountability information may be integrated into one or more social media outlets.

The system 100 may further provide for users to create networks of users or buddies. Buddy networks may allow for sharing of accountability information between users, audio and/or video bridging, and encouragement between buddies. Audio or video bridging may allow buddies to participate remotely in classes together, or may allow for communication outside of streaming a class or other video. In some embodiments, the system will enable which information to be shared with specific buddies or others via the system and/or third party social media platforms. As will be understood by one of skill in the art, much of the information stored in the system may be sensitive and confidential to participants. Such a buddy network may be particularly advantageous for participants who do not live near each other or travel frequently.

It is anticipated that a system of the present invention may provide a means for other parties to advertise to participants. Through such a system, sponsors may provide accountability and/or buddy network rewards, such as gift cards or products in return for such advertising. It is further anticipated that participants could receive a discount for agreeing to share their information with sponsors. In other embodiments, a system of the present invention may provide a shopping cart platform to participants. Through this platform participants may purchase equipment required for class and other related items. In another embodiment, the system may include headsets for participants and/or the instructor to enhance communication between all parties. In yet other embodiments, the system may include black-out zones to prevent users from streaming a class within a certain distance of the fitness club.

Referring again to FIG. 1, it is anticipated that the first 106, second 114, and third 120 computing devices may communicate with each other via a network 112, such as an intranet or the Internet. However, it is anticipated that the three computing devices may communicate by any means known in the art, now or in the future. Moreover, it is anticipated that any number of computing devices, particularly those used for display purposes, may be included in a system of the present invention. For example, a small personal training class may include a few display devices, whereas a large college class, conference, or performance may include hundreds of display devices. Furthermore, it is anticipated that any number of recording devices may be used to record any number of feeds to be stitched into an integrated feed.

Accordingly, a system of the present invention may (1) enhance the fitness club experience for an on-site participant, and (2) virtualize the experience and opportunity of belonging to a fitness club for a remote participant. Relationships between participants and instructors may be enabled, extended, and/or enhanced. This may be beneficial for participants who are unable to travel to a fitness club, but who desire the advantages that a fitness club can offer. One of these advantages is an instructor who may provide small group or one-on-one training during a fitness class. To that end, the system may be configured to create an audio and/or video bridge between a remote participant and an instructor. Therefore, the participant may ask questions, and the instructor may provide personalized instruction. In addition, it is anticipated that some tracking devices 128 may also be configured to provide for such communication and personalized remote instruction. For example, a user worn tracking device, such as a Fitbit brand device, wireless scale, heart rate monitor, or other type of tracking device. may upload information to both the participant and instructor. In addition, other types of tracking devices, such as the Xbox Kinect program may track the movements and form of a remote participant to send video or other data to the instructor for providing feedback, such as critiquing a participant's form. Furthermore, gamification may be used for the participant and/or the instructor for accountability and communication applications.

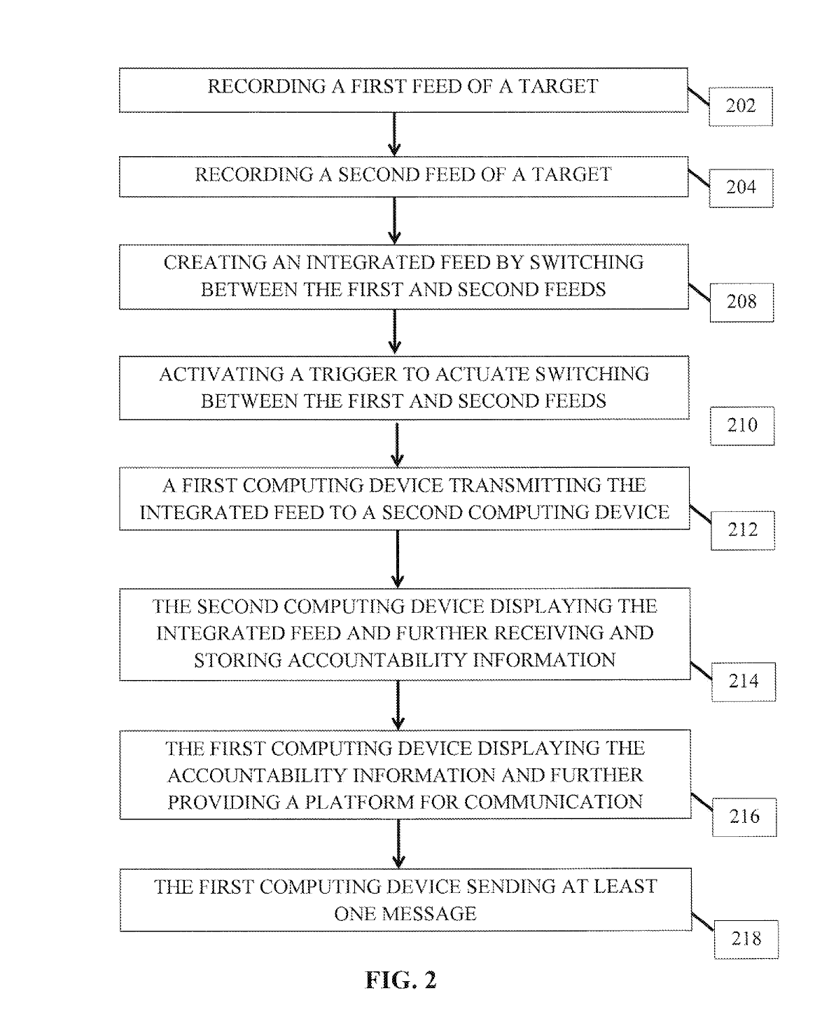

Referring to FIG. 2, a method for streaming video, accountability, and communication is shown. Referring to blocks 202 and 204, the method includes recording first and second feeds of a target, respectively. It is anticipated, however, that a method of the present invention may include recording any number of feeds. Next, as shown by block 206, an integrated feed is created by switching between first and second feeds. As discussed above, this step may be completed by a first computing device 106. As shown by block 208, the method may also including activating the trigger to actuate switching between the first and second feeds. Next, the integrated feed is transmitted by a first computing device to a second computing device, as shown by block 210. Preferably, the same first computing device 106 completes this step of the method.

Accordingly, as shown by block 212, the second computing device displays the integrated feed. The second computing device may also receive and store accountability information. Furthermore, as provided in block 214, the second computing device may communicate or transmit the accountability information to the first computing device for data retention in a system database. Referring to block 216, the first computing device may display the accountability information. In addition, the first computing device may provide a platform for communication. Furthermore, the first computing device may send a least one message, such as to a user of the second computing device, as shown by block 218.

As will be appreciated by one of skill in the art, the above-described method may include any number of display devices displaying the integrated feed and providing communication and/or social media outlets for users. Moreover, the above steps need not occur in the order described. Rather, the steps may occur in any order, including simultaneously. A method of the present invention may be used in any of a number of circumstances, such as by viewers of a fitness class, conference, speech, or any other type of performance.

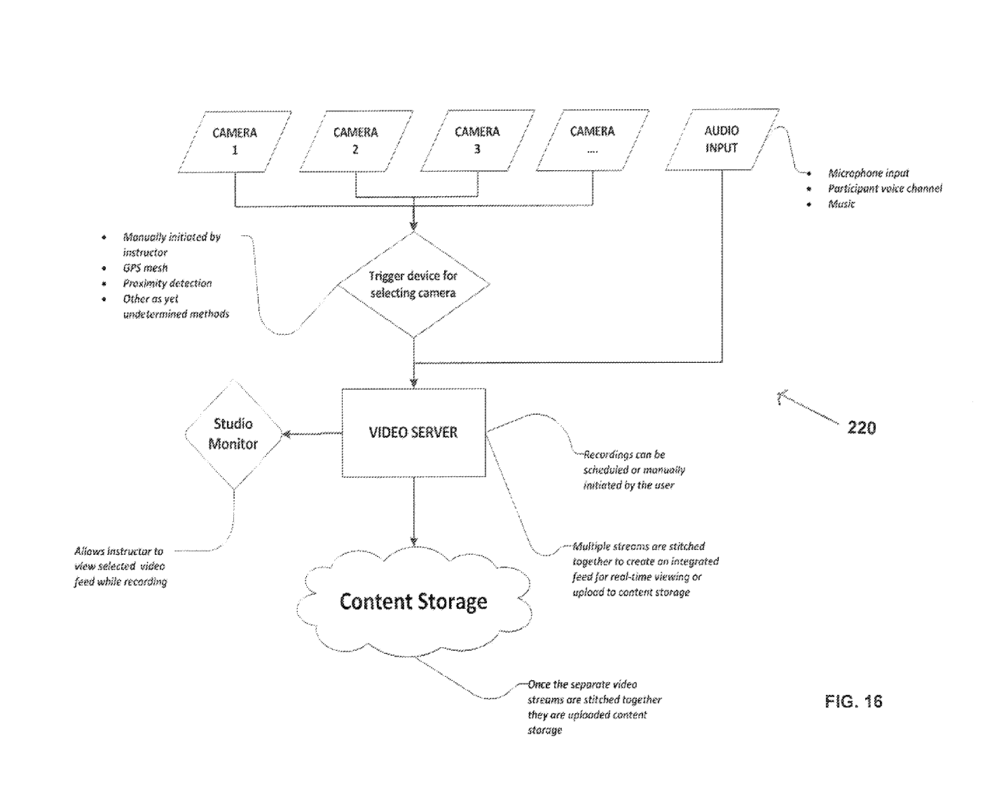

Referring to FIGS. 16-24, a number of illustrations are provided for an exemplary system of the present invention. It will be understood by one of skill in the art that the illustrations and corresponding descriptions are provided as one example of a preferred embodiment only. Other systems, logic, and programming may be used without departing from the scope of the invention. Referring to FIG. 16, a diagram for stitching multiple video feeds 220 in accordance with an exemplary system of the present invention is shown. As described above, multiple video feeds from multiple video recording devices are inputted into the system and coordinated using at least one trigger 126 to select which video feed is shown at a given time. As described above, a trigger can include a manual push-button fob, a GPS mesh, proximity detection, face tracking, etc. without departing from the scope of the present invention. The video feeds, trigger data, and audio feeds are stored in a first computing device 106 which functions as a server. Audio feeds of the present invention can include microphone in for an instructor, participant audio, and music. As depicted in FIG. 16, the server 106, which for purposes of illustration is provided as a “Video Server” but may be any type of server known in the art now or in the future, provides for a local monitor to view the integrated video feed in real-time. Additionally, the server 106 provides storage of the integrated feed either locally or on a content storage platform such as a cloud storage service.

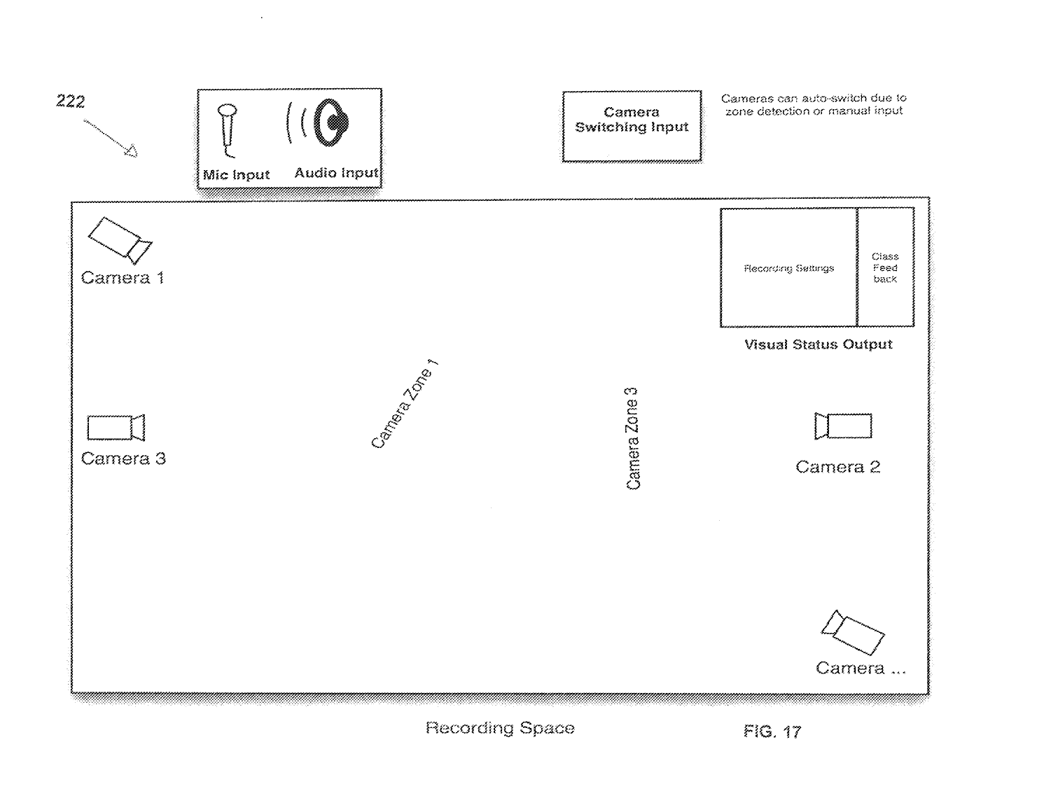

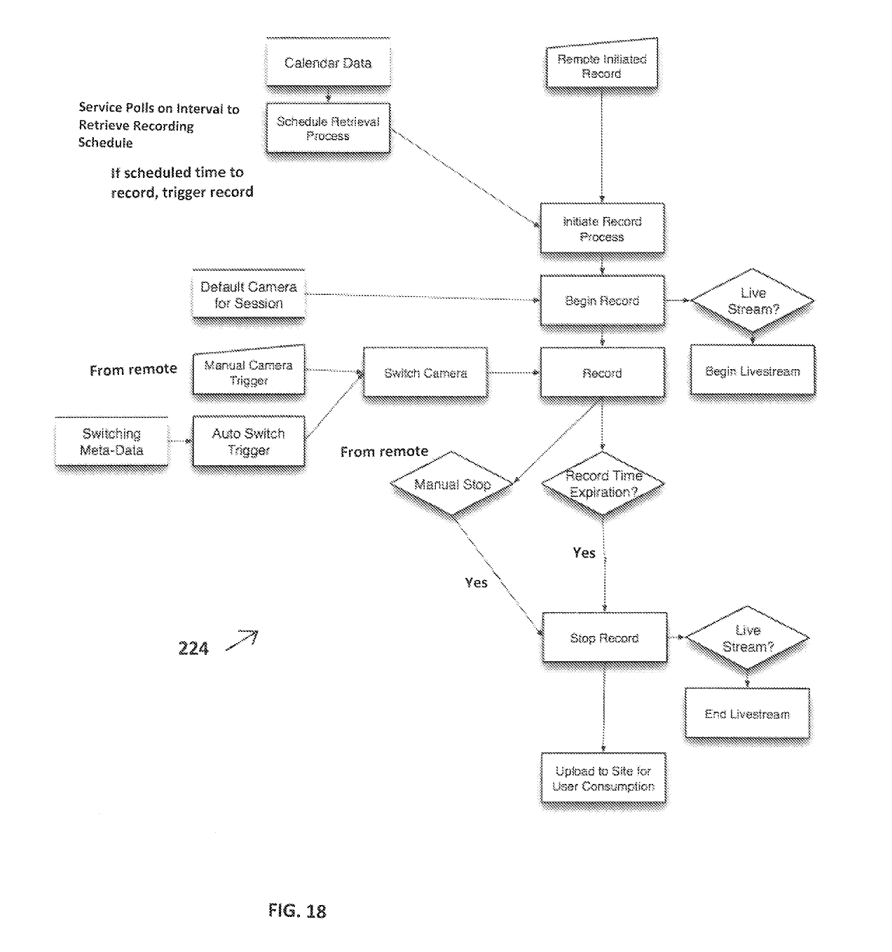

Referring to FIG. 17, a diagram of a recording space 222 is shown. A first recording device 102 is located opposite and adjacent to a second recording device 104 within the recording space. It is contemplated additional recording devices may be added to the recording space without departing from the scope of the present invention. As depicted, a first computing device 102 may switch recording devices 102 and 104 and their respective feeds based on whether or not a subject is within the depicted zones based on pre-determined recording settings and class feedback. FIG. 18 depicts a flow chart of the recording logic 224 executed by the system to initiate recording, switch recording device feeds, coordinate live-streams, and stop recordings. As depicted, the system provides for the ability to initiate and end recordings based on a predetermined schedule from a calendar, or other similar source, as well as the ability to switch recording feeds based on trigger data sent to the system.

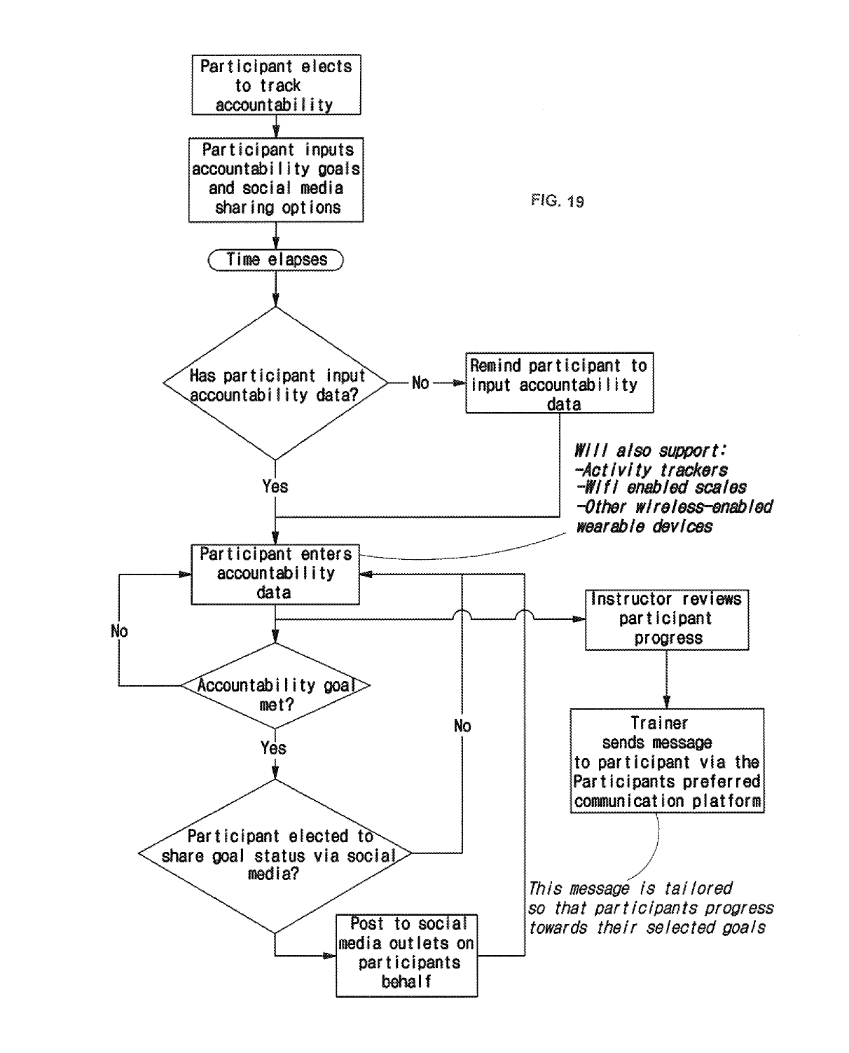

Referring to FIG. 19, a flow chart describing the system logic 226 for a user to initiate and input accountability tracking on the system is shown. The system of the present invention will periodically check whether accountability information has been inputted and, if not, request data from the user. Additionally, the system provides a user with the ability to elect to automatically share a goal via one or more social media platforms when the goal is met. The system also allows an instructor to review a user's progress, if they have elected to allow same. Moreover, the system allows an instructor to message a user on the progress of achieving their goal with one or more parts of the message pre-populated with information on the user available to the system 100.

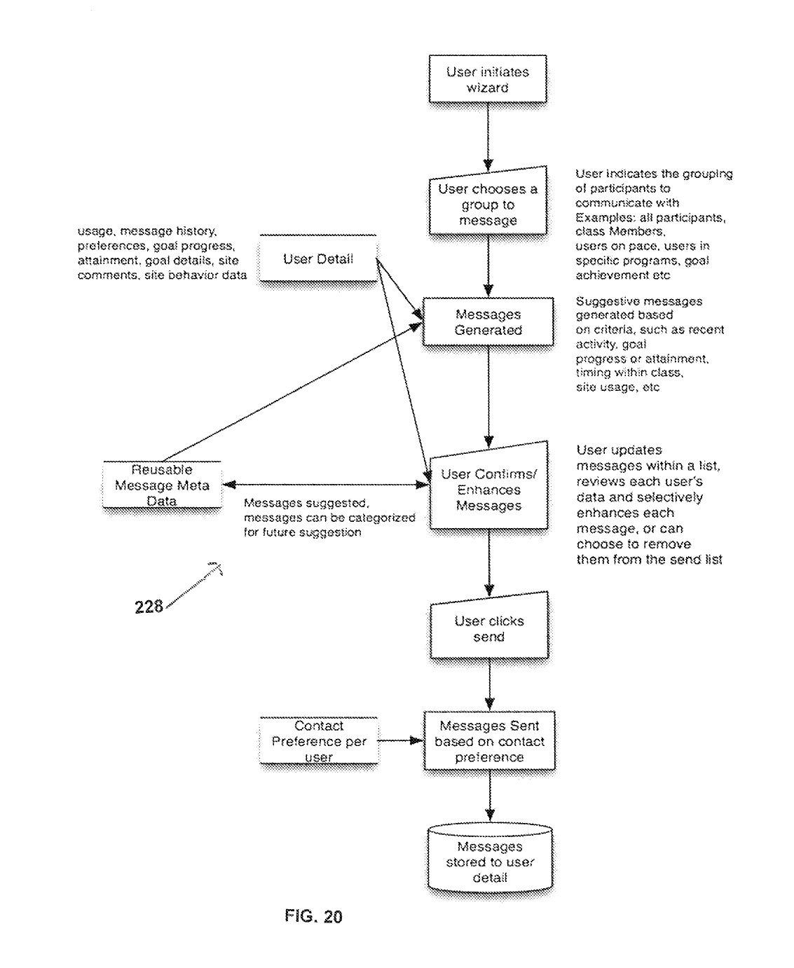

Referring now to FIG. 20, a flow chart of the pre-populated messaging platform logic 228 of the system is depicted. The user can be an administrator, an instructor, or any user granted sufficient privileges within the system to access the messaging platform. The pre-populated messaging platform allows a user. i.e. an instructor, to select another user or group of users to message. Contemplated groups an instructor could message include all members of a class, users on pace to reach goals, users in specific programs, etc. However, it should be appreciated by one skilled in the art that additional group classifications could be added to the messaging platform without departing from the scope of the present invention. Once a user or group of users is selected, the system, utilizing information available to it—including information stored in the first computing device 102 and information from third-party databases the system is granted access to—pre-populates a message template with relevant information on each user. The instructor may then confirm or enhance each message and confirms or removes each user to be messaged from a list generated by the system. If the message is enhanced before sending, the system provides the ability to categorize each enhancement for future use as well as updating subsequent messages in the group to reflect the enhancements made.

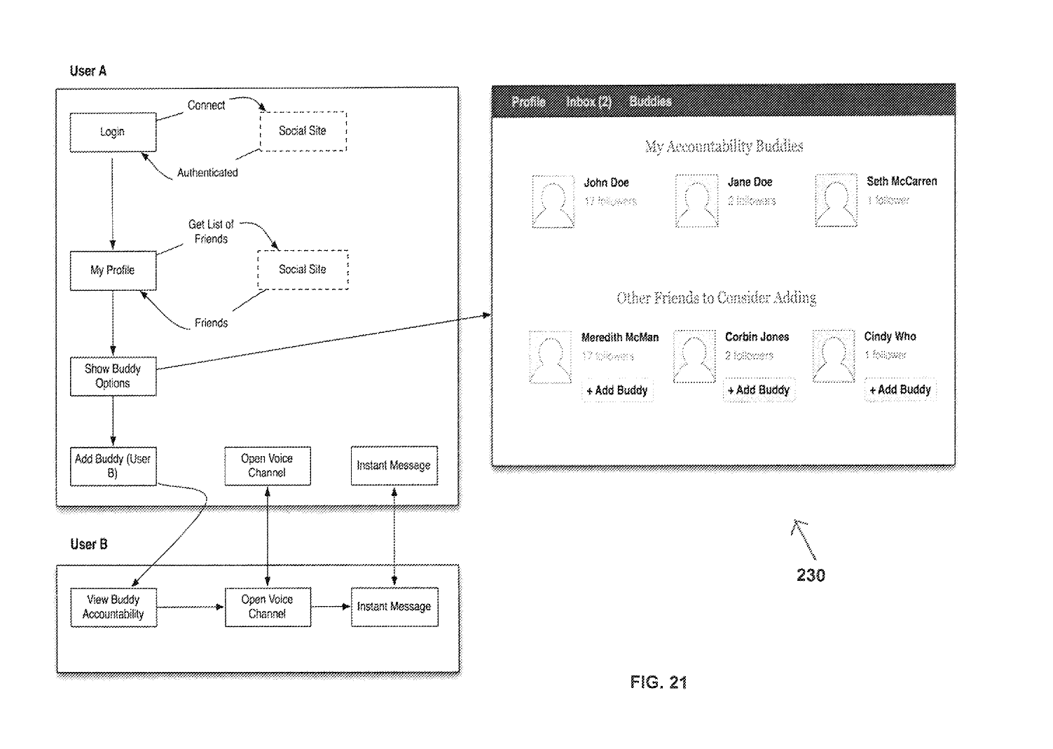

Referring to FIG. 21, program logic for a multi-user messaging and communication platform 230 is provided. The system of the present invention provides users with the ability to login to the system using credentials from other databases such as a social media site. Additionally, the system may import friend lists from a social media site with permission from a user. Once a user selects another user to communicate with, the system allows the user to open an audio channel or instant messaging channel to communicate with the other selected user. It should be appreciated by one skilled in the art that a video channel for video chat may be provided by the system without departing from the scope of the present invention.

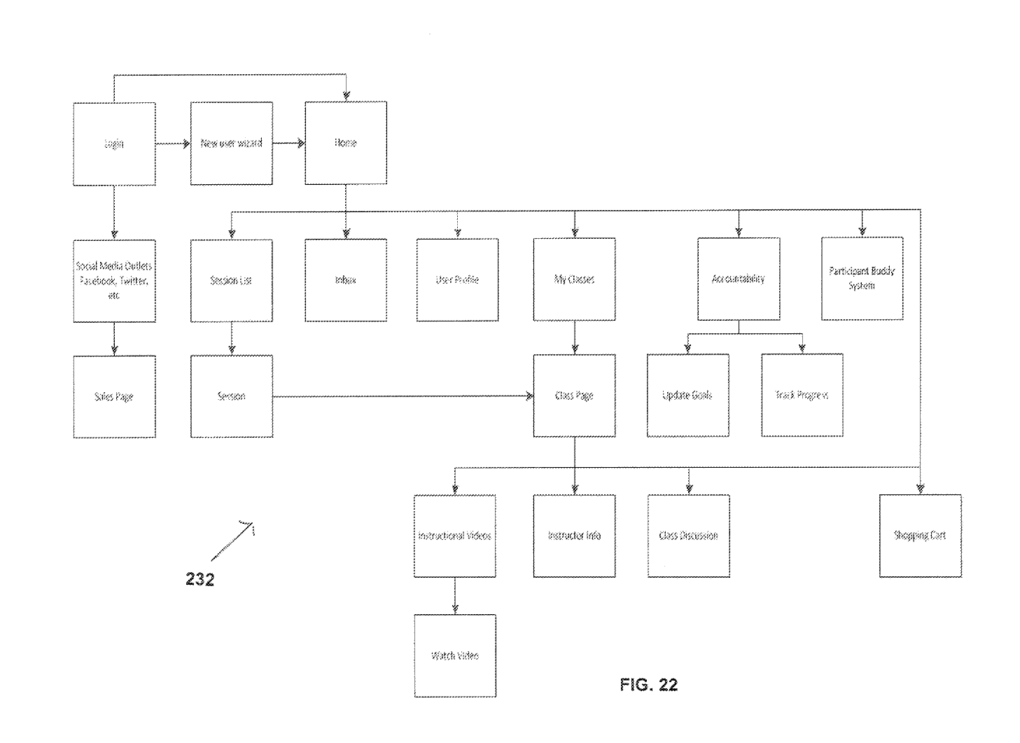

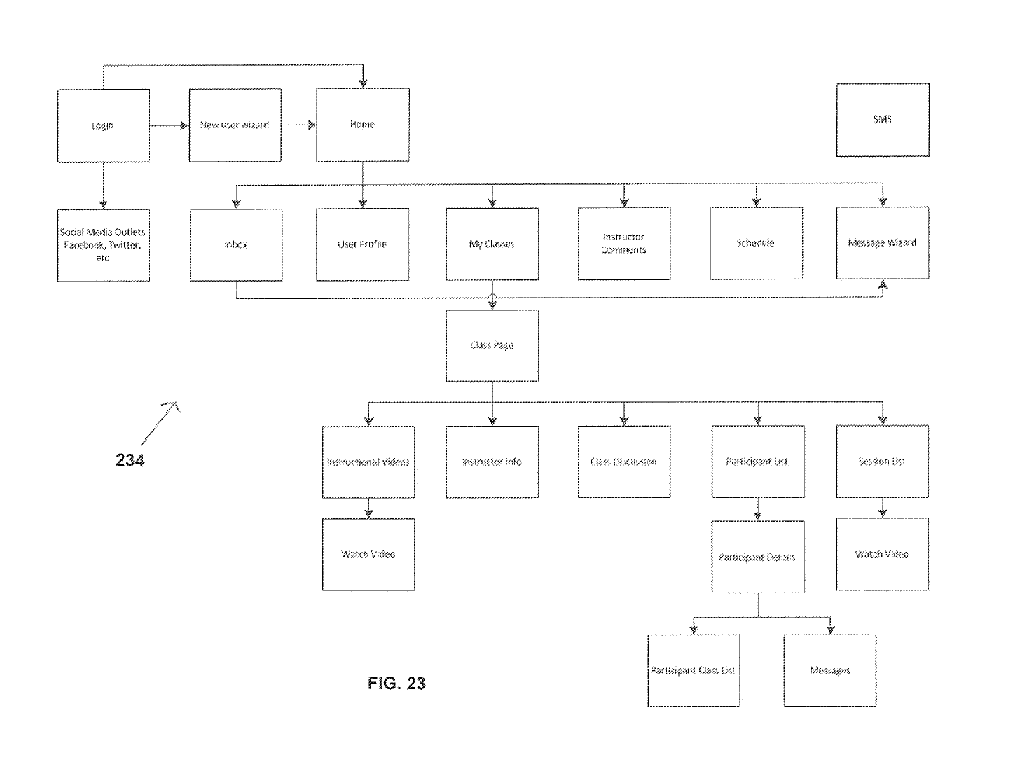

Referring to FIGS. 22-23, user interface maps of a system of the present invention are provided for various user types 232, 234. FIG. 22 depicts the interfaces available to a general user, student, or participant of the system 100. FIG. 23 depicts the interfaces available to an instructor and/or administrator of the system 100. It is contemplated the primary difference in access to the system between an instructor and an administrator is the ability to edit data within the system 100. While an instructor would be able to edit certain areas of the system 100, such as the “Instructor Information” interface, they would be unable to edit other areas, such as participant class list. However, it is contemplated an administrator would have full access to the system and the ability to edit data within any interface. It should be appreciated by one skilled in the art that the various implementations of the interfaces and permissions to same may be modified or re-arranged without departing from the scope of the present invention.

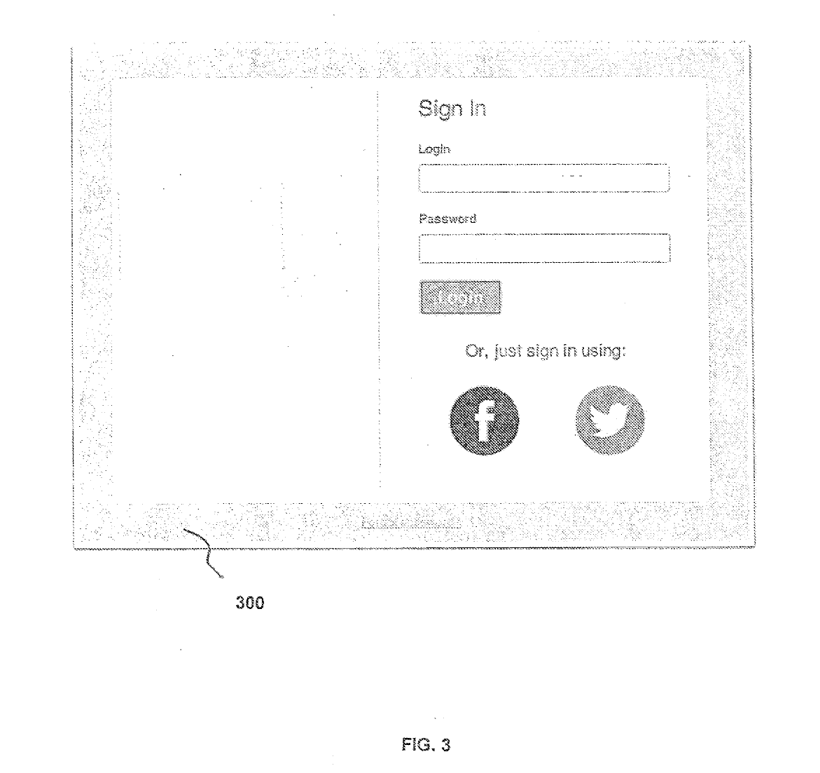

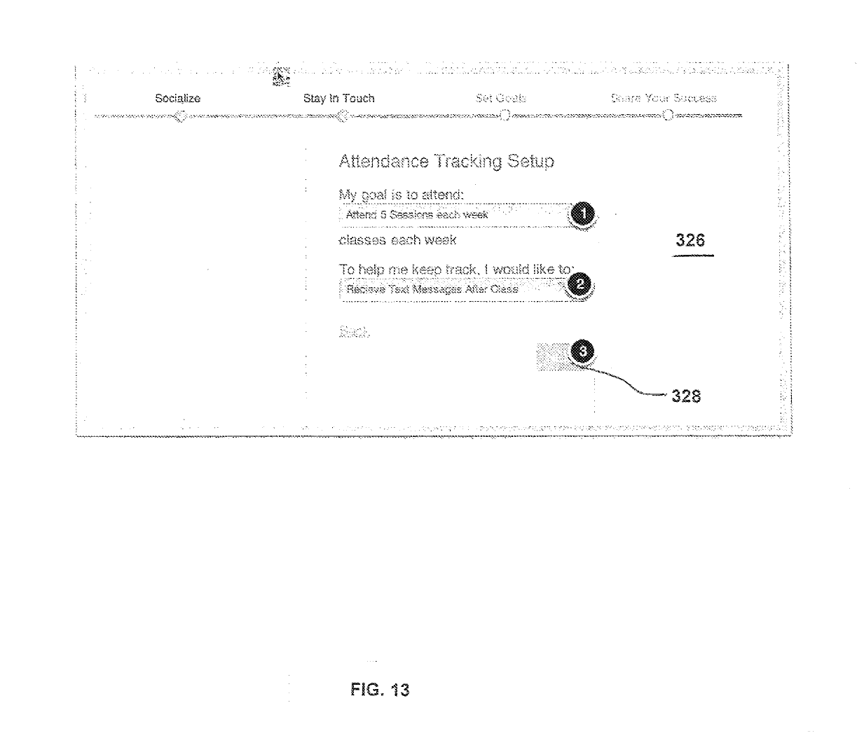

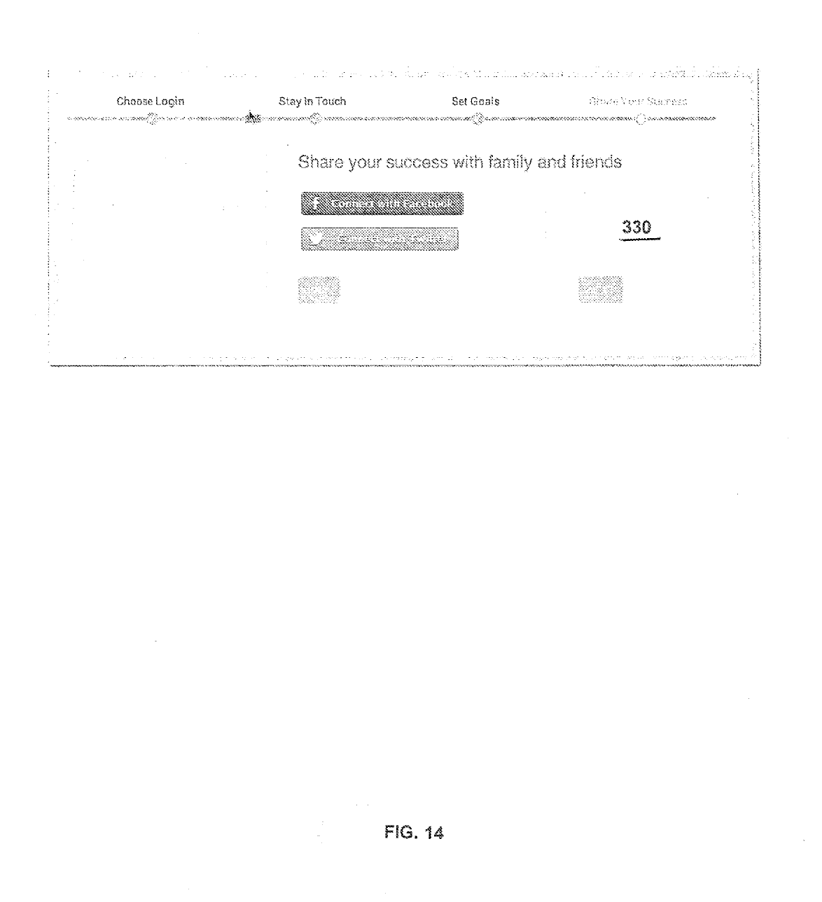

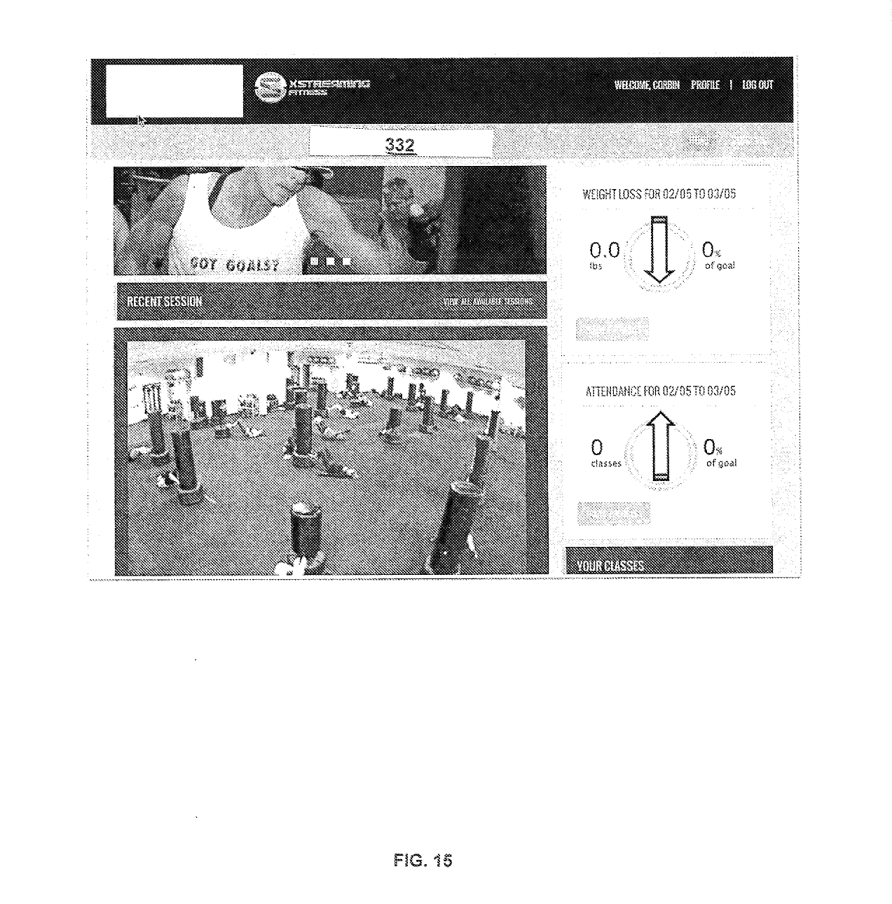

Referring to FIGS. 3-15, sample user interfaces of a system of the present invention are provided. In the preferred embodiment, the first computing device 106 discussed above, is located a fitness club and may be a server. The participant portion of the system may be web-based and viewed through a thin client, such as a web browser. It is anticipated that any configuration may be used. For example, in one embodiment, the participant may use a mobile app. It will be understood by one of skill in the art that the provided user interface samples are exemplary only and should not be construed as limiting. User interfaces of a system of the present invention may take any form desired by a user of the system 100. Furthermore, the sample user interfaces are directed toward an embodiment of the invention involving fitness instruction and goals. As discussed above, a system of the present invention, and accordingly user interfaces, may be directed to many topics. Turning to FIG. 3, an instructor sign-in screen 300 is shown, providing multiple methods for an instructor to sign-in to the system. For example, a login and password may be supplied, or the instructor may sign in via Facebook or Twitter. Of course, other social media accounts known now or in the future may be used.

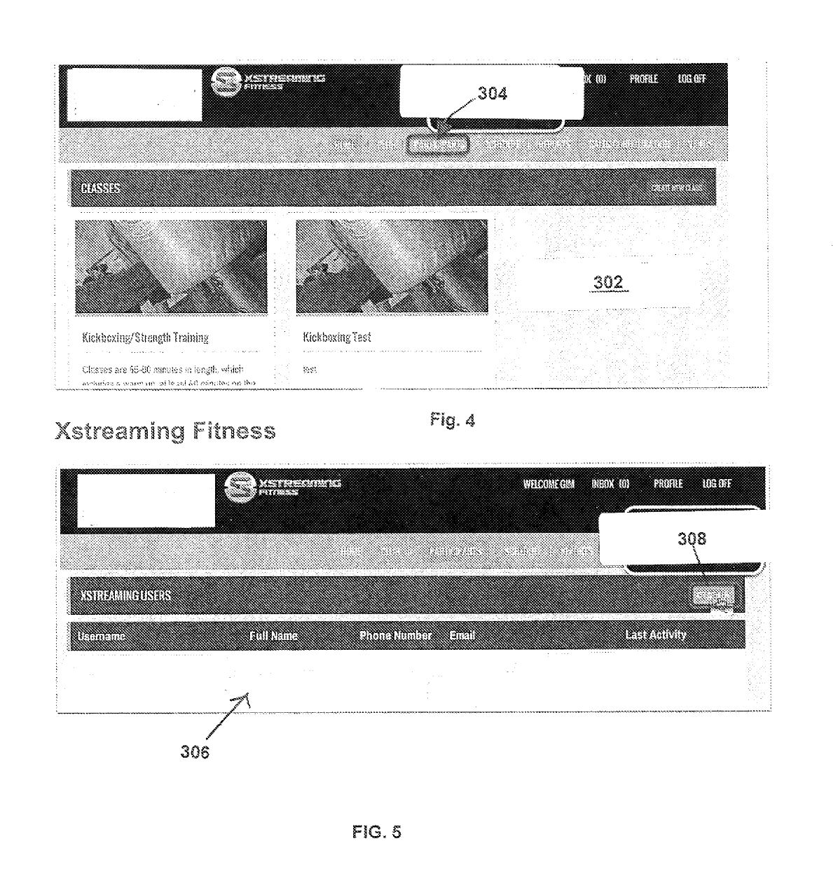

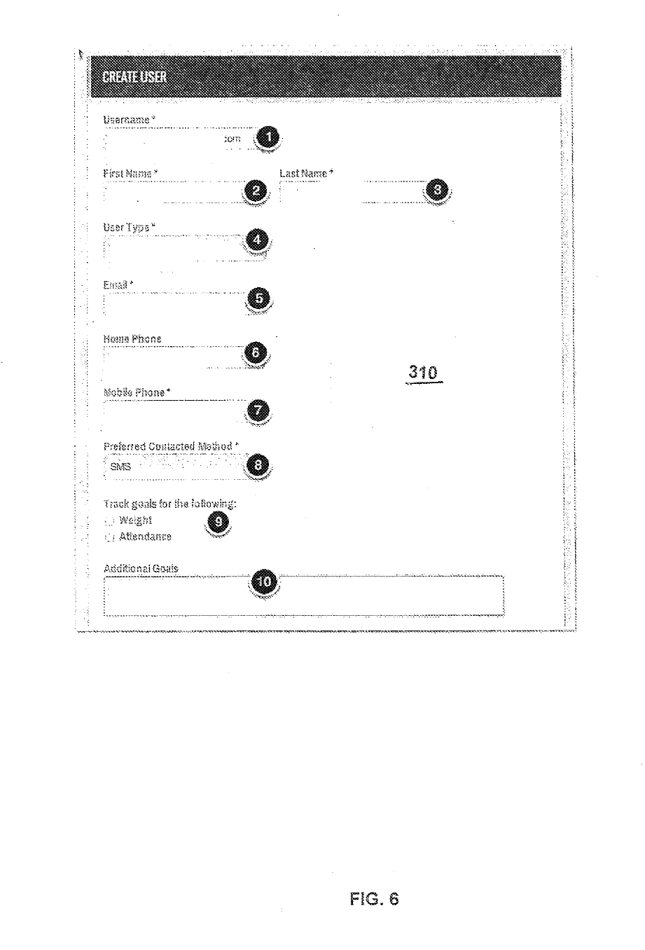

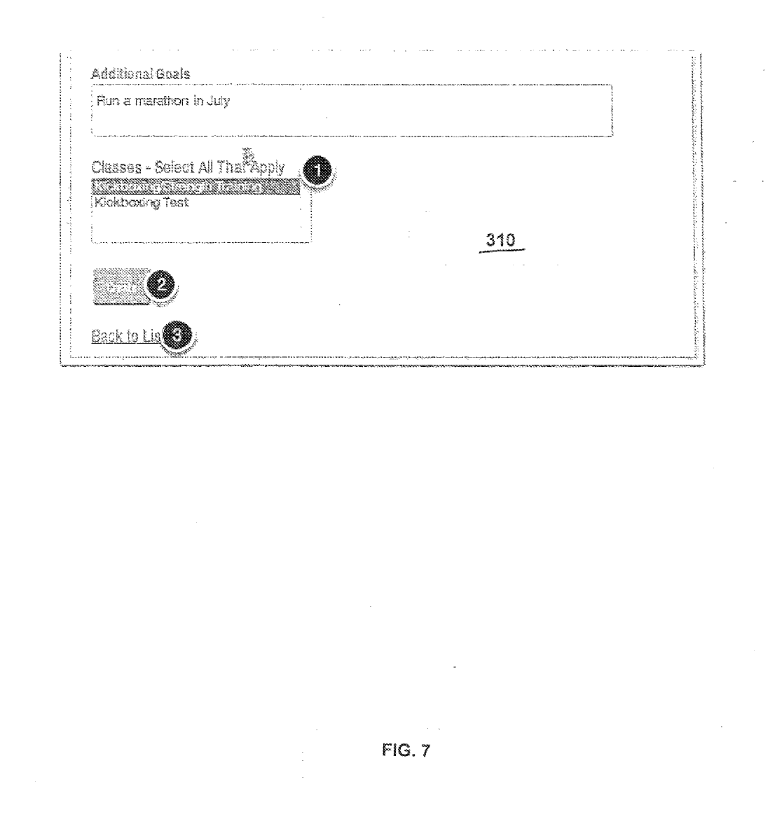

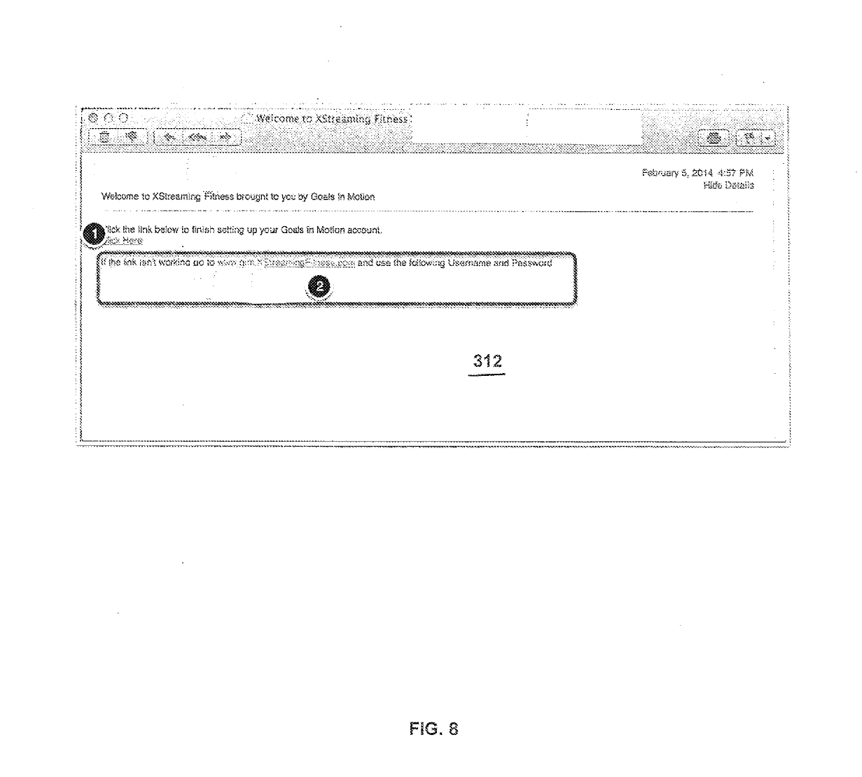

Turning to FIG. 4, an instructor home screen 302 is shown. The instructor may view information related to his club, participants, schedule, reports, sales, and videos. The instructor may also, view his inbox and profile, as well as create a new class and log out of the system. By clicking the “PARTICIPANTS” link 304, the instructor may be taken to the instructor participant's page 306 shown in FIG. 5. At this page, the instructor may view current participants, as well as add new participants by clicking the “CREATE NEW” button 308. The “CREATE NEW” button 308 leads to a create user page 310 shown in FIGS. 6 and 7, where the instructor may enter information about the new user including, a username, first and last names, user type, which will be discussed in further detail below, email address, home phone, mobile phone, preferred contact method, goals to be tracked, and additional goals. Furthermore, referring to FIG. 7, the instructor may choose which classes the participant will attend. Once a participant is added by the instructor, a confirmation message 312 will be sent to the participant, as shown in FIG. 8. The confirmation message 312 will include instructions for the new participant to complete set-up of the account.

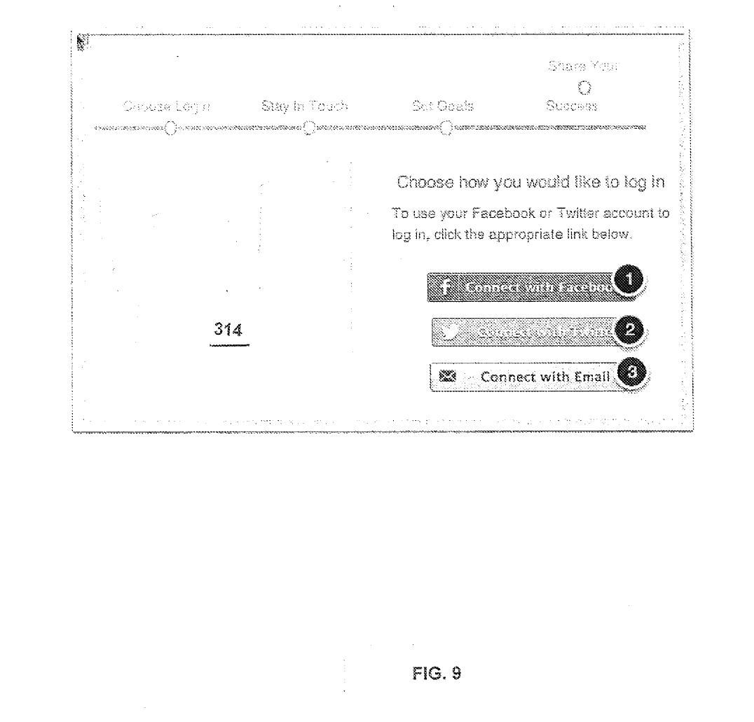

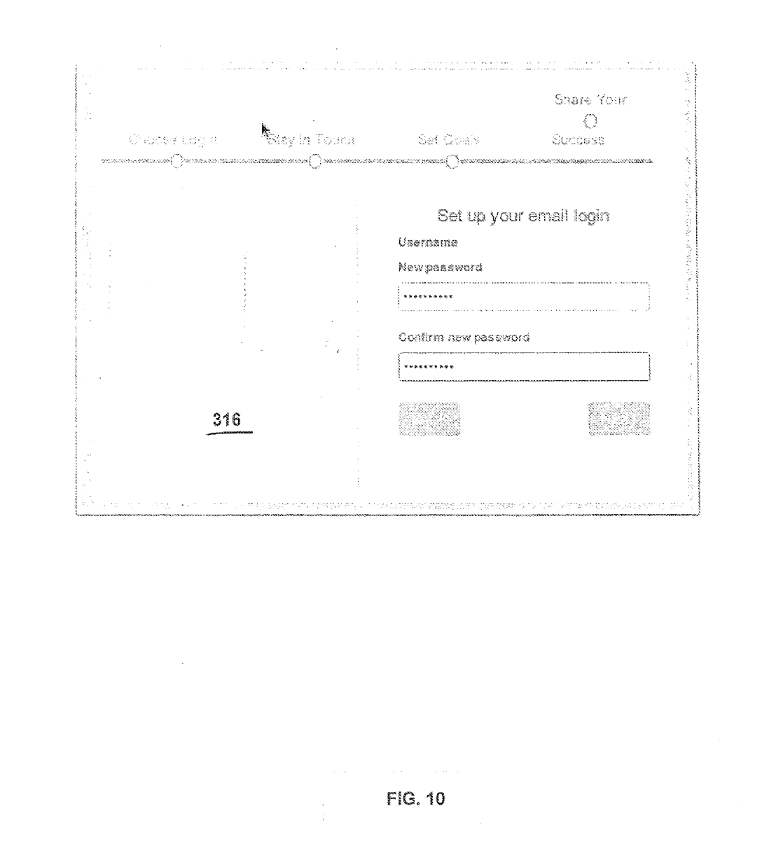

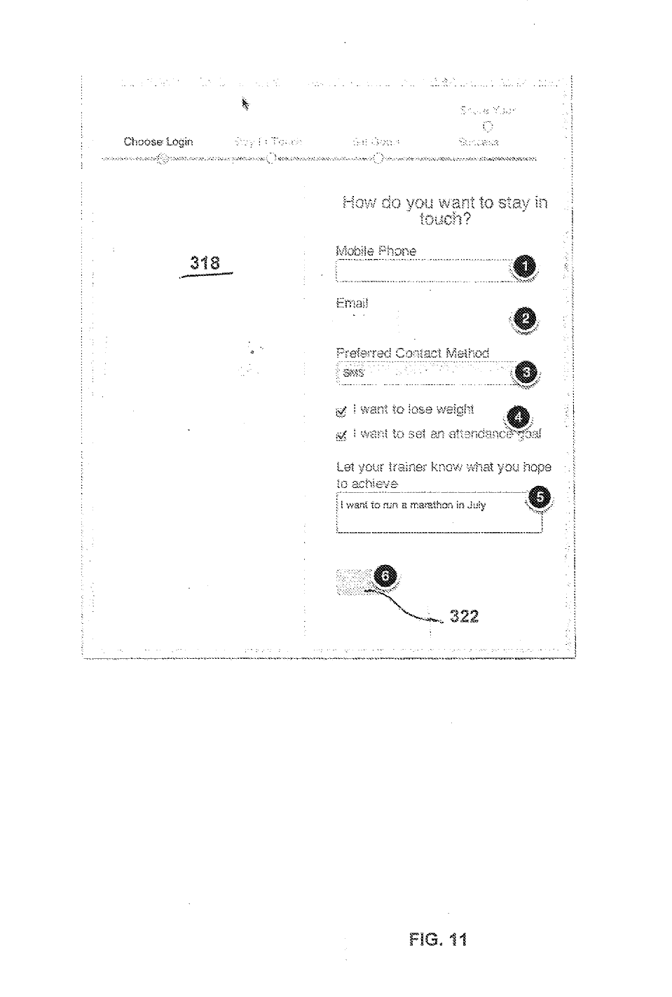

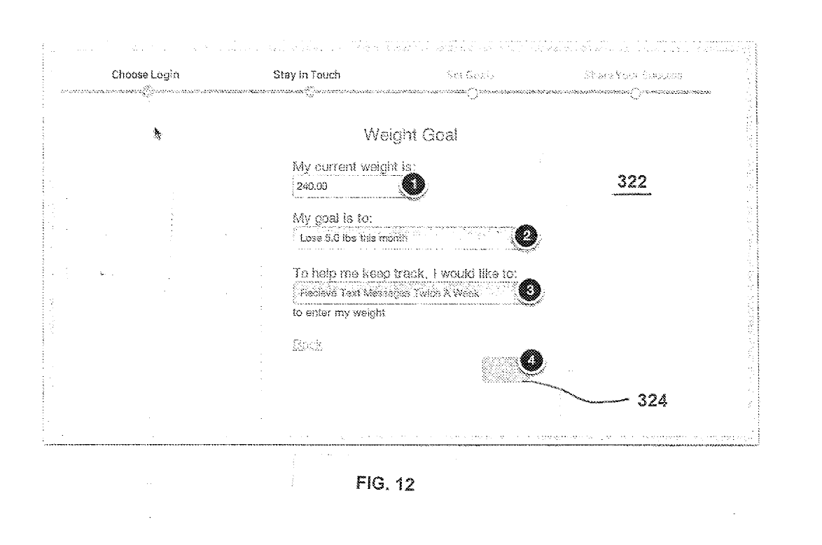

Referring to FIG. 9, the participant login screen 314 is shown. The participant may login using email, as well as Facebook or Twitter login information. Turning to FIG. 10, the participant email login screen 316 is shown. To complete set-up of the account, the user is taken to the “Stay In Touch” screen 318 shown in FIG. 11, where the participant may enter or update his mobile phone number, email address, preferred contact method, and goals. Also included is a “NEXT” button 320, which leads the participant to one or more “Set Goals” screens. Referring to FIG. 12, a “Weight Goal Screen” 322 is provided. At the “Weight Goal Screen” 322, the user may enter his starting, benchmark weight information, which is only seen by the participant and the instructor. The participant may enter the amount of weight he hopes to lose or gain per month. In addition, the participant may select one of a number of communication options for staying on track. The options may include, but are not limited to: (1) receiving text messages twice per week which ask the user to provide his current weight for updating the system; (2) receiving a text message once per week which asks the user to provide his current weight for updating the system; (3) receive a text message every other week which asks the user to provide his current weight for updating the system; and (4) not to receive text messages. The participant may then click the “NEXT” 324 button to continue setup.

Doing so leads the user to the “Attendance Tracking Setup Screen” 326. At this screen, the participant may enter his attendance goal, which may be the number of sessions the participant hopes to attend per week. In addition, the participant may select whether to receive communication to help him keep track. Specifically, the participant may choose to receive text messages that will be sent immediately after class and inquiring whether the participant attended class. The participant may respond to the text message, and the answer will update the system. The participant may then click the next button 328, which will direct him to the “Share Your Success Screen” 330. The participant may choose to share his accomplishments with friends on Facebook or Twitter. If the participant chooses to do so, he will be sent to further screens to configure this option (not shown).

Once setup is complete, the participant will be taken to the participant home screen 332. Here, the participant may track his progress toward goals and view sessions. As discussed above, the instructor will select a participant type for each participant. Participant types include (1) on-line, which is a user who will only attend classes via the website and who will take classes on their own time (text messages regarding attendance may not be used for these participants); (2) on-site, which is a user who will attend classes in-person at the club; and (3) mixed, which is a user who will attend class in person in the club, but also supplement those classes online (these participants will receive text messages regarding attendance if so chosen). Accordingly, the system of the present invention has the advantage of providing a fitness club class and experience to all participants, even those who do not attend classes in person. In addition, the system of the present invention further has the advantage of enhancing the experience of all participants, including those who attend class both in-person and remotely. All types of participants are able to receive personalized and one-on-one communication from an instructor.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between a network connection of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

1. A system comprising:
a first recording device to record a first feed of a target;
a second recording device to record a second feed of said target;
a trigger;
a first computing device comprising:
a first processor
a first machine readable medium storing a first set of instructions that, when executed by said first processor, cause said first processor to execute a first set of operations comprising:
receiving at least one signal from said trigger;
stitching said first feed and said second feed into an integrated feed; and
transmitting at least one of said first, second, and integrated feeds;
wherein said trigger is activated to transition said integrated feed between said first feed and said second feed; and
wherein said target activates said trigger to transition between said first feed and said second feed to create said integrated feed.

2. The system of claim 1 further comprising a second computing device comprising a second processor and a second machine-readable medium storing a second set of instructions that, when executed by said second processor, cause said second processor to execute a second set of operations comprising displaying at least one of said first, second, and integrated feeds.

3. The system of claim 2 wherein at least one of said first and second sets of operations further comprises providing at least one of a communication outlet and a social media outlet.

4. The system of claim 1 wherein said first set of instructions further comprises providing a platform for said first computing device user to communicate with a second computing device user.

5. The system of claim 2 wherein said second set of instructions further comprises providing a platform for a second computing device user to enter accountability information.

6. The system of claim 5 wherein said accountability information is selected from the group consisting of a goal, progress towards a goal, and combinations thereof.

7. The system of claim 6 wherein said accountability information may be linked to at least one social media platform.

8. The system of claim 1 wherein said target is an instructor.

9. The system of claim 1 wherein said first feed, second feed, and integrated feed are selected form the group consisting of a fitness class, speech, security camera feed, performance, and a conference.

10. The system of claim 2 wherein said first and second computing devices are selected from the group consisting of a desktop computer, a laptop computer, a tablet computer, a gaming console, a mobile phone, a server, and a television.

11. The system of claim 1 wherein said trigger is global positioning system enabled.

12. A computer-implemented method comprising:
providing at least a first computing device;
storing accountability information in a database which is entered by at least one of a user and a tracking device; and
displaying said accountability information and providing a communication platform for electronic communication between at least two users.

13. The computer-implemented method of claim 12 further comprising:
a first computing device comprising a first processor and a first machine-readable medium storing a first set of instructions instructing said first processor to provide a communication platform and store accountability information entered in said database by at least one of said user and said tracking device;
a second computing device comprising a second processor and a second machine-readable medium storing a second set of instructions instructing said second processor to provide a communication platform between users of said first computing device and said second computing device; and
said first and second computing devices connected to a network.

14. The computer-implemented method of claim 12 further comprising:
a first computing device comprising a first processor and a first machine-readable medium storing a first set of instructions instructing said first processor to provide a communication platform and store accountability information entered in said database by at least one of said user and said tracking device;
a second computing device comprising a second processor and a second machine-readable medium storing a second set of instructions instructing said second processor to provide a communication platform between at least two of said first computing device, said second computing device and a third computing device;
said third computing device comprising a third processor and a third machine-readable medium storing a third set of instructions instructing said third processor to provide a communication platform between at least two of said first, second and third computing devices; and
said first, second and third computing devices connected to a network.

15. The computer-implemented method of claim 12 further comprising:
a first computing device comprising a first processor and a first machine-readable medium storing a first set of instructions instructing said first computing device to function as a server connected to a network having at least one user computing device; and
said at least one user computing device comprising a second processor and a second machine-readable medium storing a second set of instructions instructing said processor to provide users of said at least one user computing device with communication from said first computing device.

16. The computer-implemented method of claim 15 wherein:
said first computing device functioning as a server connected to a network and further providing a communication platform between said at least one user computing device and said first computing device;
said first computing further providing a database to store information from said at least one user computing device; and
said first computing further providing a database to store information from at least one said tracking device.

17. The computer-implement method of claim 12 wherein said electronic communication is selected from the group consisting of text message, short message service, email, social media, and combinations thereof.

18. The computer-implemented method of claim 12 wherein said accountability information may be shared on social media.

19. The computer-implemented method of claim 12 further comprising providing at least one of an audio or video bridge between said first and second computing devices.

20. A computer-implemented method comprising:
recording a first feed of a target;
recording a second feed of said target;
creating an integrated feed by switching between said first feed and said second feed, said switching actuated by a trigger, said trigger activated by said target;
a first computing device transmitting said integrated feed to a second computing device, said second computing device displaying said integrated feed;
said second computing device receiving and storing accountability information, said second computing device further communicating said accountability information to said first computing device;
said first computing device displaying said accountability information and providing a platform for a first user to communicate with a second user of said second computing device.

21. The computer-implemented method of claim 20 further comprising said first computing device sending at least one message to said user based on said accountability information.

22. The computer-implemented method of claim 21 wherein said accountability information is selected from the group consisting of a goal, progress toward said goal, class attendance, and combinations thereof.
